(19) United States
(12) Patent Application Publication
(10) Pub. No.: US 2014/0125835 A1
(43) Pub. Date: May 8, 2014

(54) Visual Media on a Circular Buffer

(71) Applicants: Shane D. Voss, Fort Collins, CO (US); Jason Yost, Windsor, CO (US); Tanvir Islam, Fort Collins, CO (US)

(72) Inventors: Shane D. Voss, Fort Collins, CO (US); Jason Yost, Windsor, CO (US); Tanvir Islam, Fort Collins, CO (US)

(21) Appl. No.: 14/233,142

(22) PCT Filed: Jul. 22, 2011
(86) PCT No.: PCT/US2011/045066

§ 371 Date: Jan. 15, 2014

(51) Int. Cl. H04N 5/232

(52) U.S. Cl. CPC H04N 5/23222
USPC 348/222.1

(57) ABSTRACT

A device to capture visual media, transiently store the visual media on a circular buffer, detect for a trigger from an environment around the device, and store the visual media on a location of a storage component separate from the circular buffer in response to detecting the trigger.

### BACKGROUND

When using a device to capture visual media, a user can initially identify one or more objects, people, and/or scenes within view of the device to capture the visual media of. The user can then manually access one or more input buttons of the device to initiate the capture of visual media. While the user is determining what to capture and while accessing the input buttons of the device, a desirable event or scene may occur and pass before the user can successfully capture visual media of the event or scene.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with an image capture component according to an example implementation.

FIG. 2 illustrates a device with an image capture component, a sensor, and a circular buffer according to an example implementation.

FIG. 3 illustrates a block diagram of visual media being stored on a storage component from a circular buffer according to an example implementation.

FIG. 4 illustrates a block diagram of a media application determining whether to retain visual media based on a user reaction according to an example implementation.

FIG. 5 illustrates a media application on a device and the media application stored on a removable medium being accessed by the device according to an example implementation.

FIG. 6 is a flow chart illustrating a method for managing visual media according to an example implementation.

FIG. 7 is a flow chart illustrating a method for managing an image according to an example implementation.

### DETAILED DESCRIPTION

A device with an image capture component can capture visual media and transiently store the visual media on a circular buffer. For the purposes of this application, a circular buffer is a storage component which can be used to store recently captured visual media while existing visual media already included on the circular buffer is deleted. As a result, the device can continuously capture and transiently store visual media of a scene, an event, a person, and/or an object before an opportunity to capture the visual media has passed.

As the visual media is captured and stored, a sensor, such as an image capture component or an audio input component, can detect for a trigger from an environment around the device. The trigger can be a visual event and/or an audio event from the environment around the device. The environment corresponds to a location or place of where the device is located. In response to detecting a trigger, the device can store the visual media from the circular buffer to a location of a storage component separate from the circular buffer. By storing the visual media on a location of a storage component which is separate from the circular buffer, a convenient and user friendly experience can be created for the user by retaining desirable and interesting visual media on the storage component before the visual media is deleted from the circular buffer.

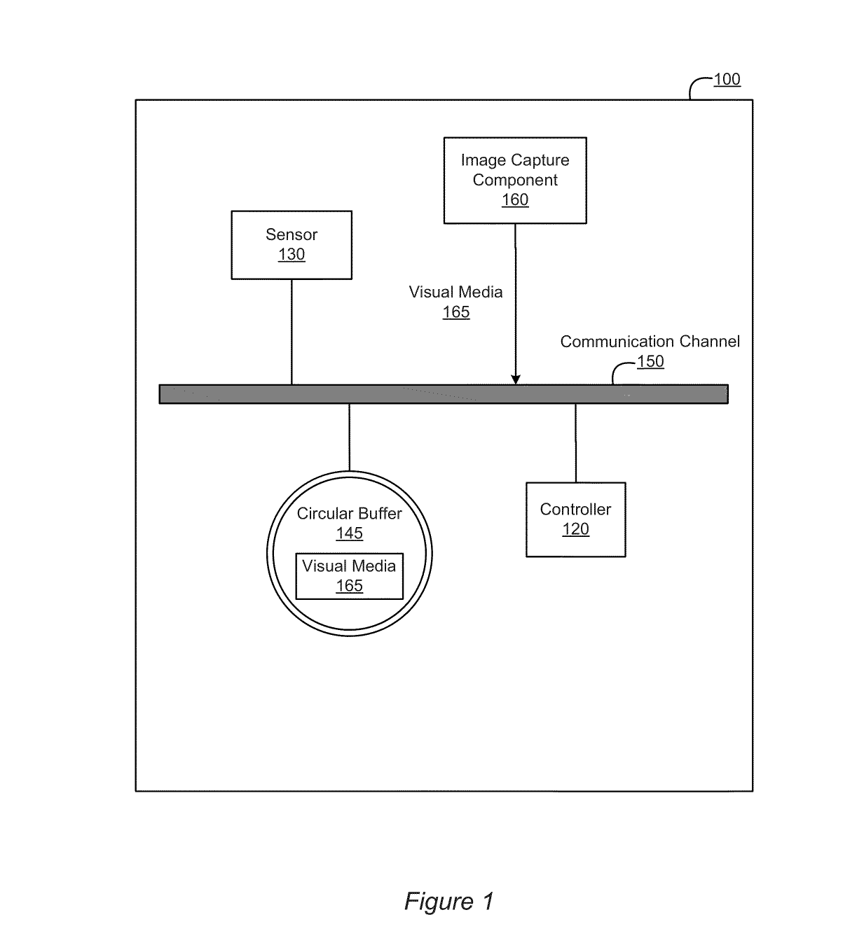

FIG. 1 illustrates a device 100 with an image capture component 160 according to an example. In one embodiment, the device 100 can be a cellular device, a PDA (Personal Digital Assistant), an E (Electronic)-Reader, a tablet, a camera, and/or the like. In another embodiment, the device 100 can be a desktop, a laptop, a notebook, a tablet, a netbook, an all-in-one system, a server, and/or any additional device which can be coupled to an image capture component 160.

The device 100 includes a controller 120, an image capture component 160, a sensor 130, a circular buffer 145, and a communication channel 150 for the device 100 and/or one or more components of the device 100 to communicate with one another. In one embodiment, the device 100 includes a media application stored on a computer readable medium included in or accessible to the device 100. For the purposes of this application, the media application is an application which can be utilized in conjunction with the controller 120 to manage visual media 165 captured by the device 100.

The visual media 165 can be a two dimensional or a three dimensional image, video, and/or AV (audio/video) captured by an image capture component 160 of the device 100. The image capture component 160 is a hardware component of the device 100 configured to capture the visual media 165 using an image sensor, such as a CCD (charge coupled device) image sensor and/or a CMOS (complementary metal oxide semiconductor) sensor. In response to the image capture component 160 capturing the visual media 165, the visual media 165 can be transiently stored on a circular buffer 145 of the device 100.

The circular buffer 145 can be a storage component or a portion of a storage component configured to transiently store visual media 165 captured from the image capture component 160. As the image capture component 160 captures visual media 165, the circular buffer 145 can be updated to store recently captured visual media 165 and existing visual media 165 stored on the circular buffer 145 can be deleted. The existing visual media 165 can be deleted in response to the circular buffer 145 filling up or reaching capacity. In another embodiment, the existing visual media 165 can be deleted in response to an amount of time elapsing.

As the circular buffer 145 transiently stores the visual media 165, a sensor 130 of the device 100 can detect an environment around the device 100 for a trigger. The sensor 130 can be an audio input component, an image capture component 160 and/or a second image capture component configured to detect for a trigger from the environment around the device 100. In one embodiment, the trigger can be an audio event, such as a laugh, a yell, a clap, an increase in volume, and/or music playing. In another embodiment, the trigger can be a visual event, such as a change in expression from a user of the device 100 or a person around the device 100, a smile from the user or a person, and/or a surprised facial reaction from the user or a person.

In response to the sensor 130 detecting a trigger, the visual media 165 can be stored on a location of a storage component separate from the circular buffer 145. For the purposes of this application, the storage component can be a non-volatile storage device which can store the visual media 165 as an image file, a video file, and/or as an AV (audio/video) file. In one embodiment, when storing the visual media onto a location of a storage component, the controller 120 and/or the media application can copy or move the visual media 165 from the circular buffer 145 to a separate location of the storage component. In another embodiment, the controller 120 and/or the media application can also delete the visual media 165 from the circular buffer 145.

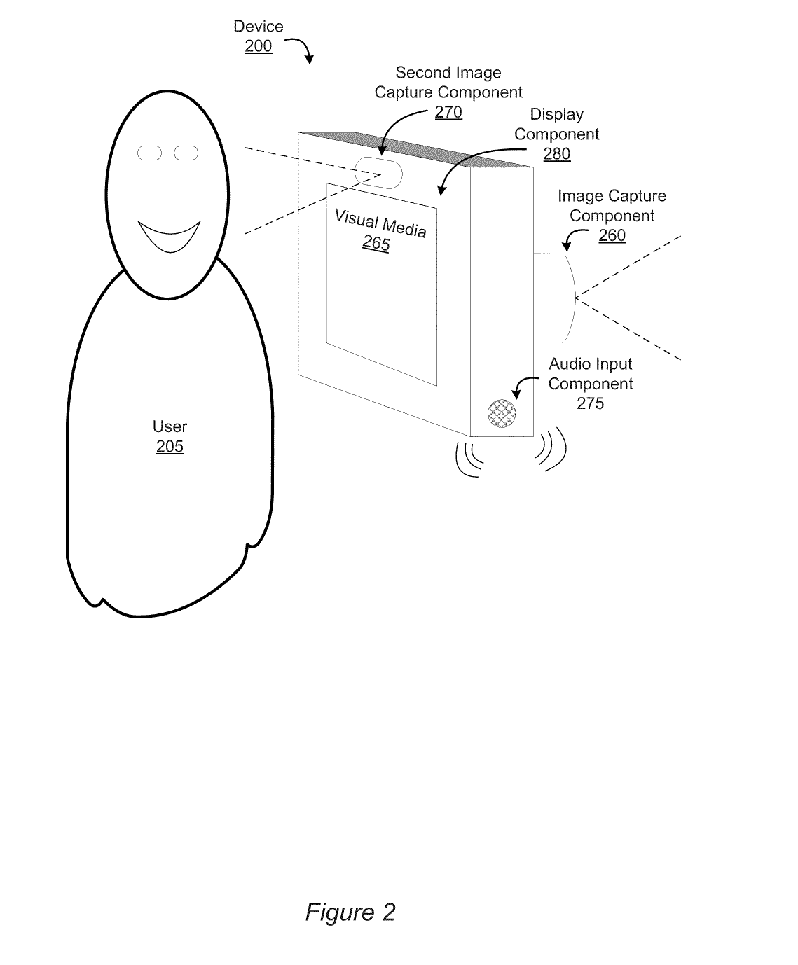

FIG. 2 illustrates a device 200 with an image capture component 260 and a sensor 230 according to an example. As noted above, the image capture component 260 is a hardware component of the device 200 configured to capture visual media 265 using an imaging sensor, such as CCD sensor and/or a CMOS sensor. In one embodiment, the image capture component 260 is coupled to a front panel of the device 200. The image capture component 260 can capture the visual media 265 of a person, an object, a scene, and/or anything else within a view of the image capture component 260. The visual media 265 can be captured as an image, a video, and/or as AV (audio/video).

The image capture component 260 can begin to capture visual media 265 in response to the device 200 powering on. In another embodiment, the image capture component 260 can begin to capture visual media 265 in response to the device 200 entering an image capture mode. The device 200 can be in an image capture mode if the image capture component 260 is enabled. Additionally, the image capture component 260 can continue to capture the visual media 265 as the device 200 remains powered on and/or as the device 200 remains in an image capture mode.

As the visual media 265 is being captured, the visual media 265 can be transiently stored on a circular buffer 245 of the device 200. The circular buffer 245 can be a storage component which can transiently store visual media 265 as it is captured by the image capture component 260. In one embodiment, the storage component can include volatile memory. In another embodiment, the storage component can include non-volatile memory.

As the image capture component 260 continues to capture visual media 265, the recently captured visual media 265 is transiently stored on the circular buffer 245. Additionally, existing visual media 265 already included on the circular buffer 245 can be deleted as the circular buffer 245 reaches capacity and/or in response to a period of time elapsing. In one embodiment, a FIFO (first in first out) management policy is utilized by the circular buffer 245 to manage the storing and deleting of the visual media 265. In other embodiments, other management policies may be utilized when managing the circular buffer 245.

As illustrated in FIG. 2, the device 200 can also include a display component 280 to display the visual media 265 for a user 205 to view. The user 205 can be any person which can access the device 200 and view the visual media 265 on the display component 280. The display component 280 is an output device, such as a LCD (liquid crystal display), a LED (light emitting diode) display, a CRT (cathode ray tube) display, a plasma display, a projector and/or any additional device configured to display the visual media 265.

As the visual media 265 is captured and transiently stored on the circular buffer 245, one or more sensors 230 of the device 200 can detect for a trigger from an environment around the device 200. For the purposes of this application, the environment corresponds to a location or place of where the device 200 is located. A sensor 230 is a hardware component of the device 200 configured to detect for an audio event and/or a visual event when detecting for a trigger. In one embodiment, the sensor 230 can include an audio input component, such as a microphone. The audio input component can detect for an audio event, such as a laugh, a yell, a clap, an increase in volume, and/or music playing. The audio event can be detected from the user 205 of the device 200 and/or from another person within an environment of the device 200.

In another embodiment, as illustrated in FIG. 2, the sensor 230 can include an image capture component. The image capture component can be the image capture component 260 used to capture the visual media 265 or a second image capture component coupled to a rear panel of the device 200. The image capture component can detect for a visual event, such as a change in expression from a user 205 of the device 200, a smile from the user 205, and/or a surprised facial reaction from the user 205.

Additionally, the visual event can be a change in expression, a smile, and/or a surprised facial reaction from another person around the device 200. In another embodiment, the visual event can be a change in brightness in the environment, in response to fireworks and/or lights turning on or off. In other embodiments, the sensor 230 can be any additional component of the device which can detect for a trigger from an environment around the device 200.

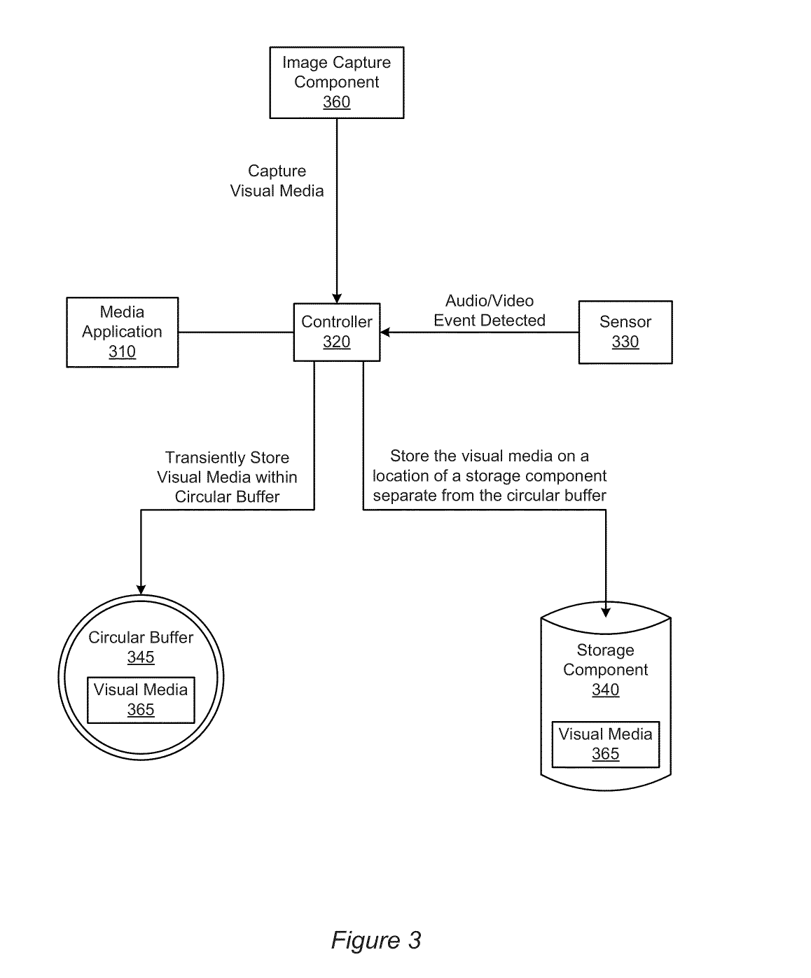

FIG. 3 illustrates a block diagram of visual media 365 being stored on a location of a storage component 340 from a circular buffer 365 according to an example. The visual media is 365 can be continuously captured from the image capture component 360 and is transiently stored on the circular buffer 345. As shown in FIG. 3, a sensor 330 of the device detects for a trigger in the form of an audio event and/or a video event. In response to detecting a trigger, the media application 310 and/or the controller 320 proceed to store the visual media 365 from the circular buffer 345 onto a location of a storage component 340.

As noted above, the storage component 340 is a non-volatile storage device which can store the visual media 365 as an image file, a video file, and/or as an AV (audio/video) file. In one embodiment, the circular buffer is 345 is included on a location of the storage component 340 and storing the visual media 365 on the storage component 340 includes the media application 310 and/or the controller 320 copying or moving the visual media 365 from the circular buffer 345 to another location of the storage component 340.

In another embodiment, the circular buffer 340 is included on another storage component separate from the storage component 340. Storing the visual media 365 on the storage component 340 includes the media application 310 and/or the controller 320 copying and/or moving the visual media 365 from another storage component with the circular buffer 345 to the storage component 340. In other embodiments, the media application 310 and/or the controller 320 can additionally delete the visual media 365 from the circular buffer 345 once it has been stored onto a location of the storage component 340.

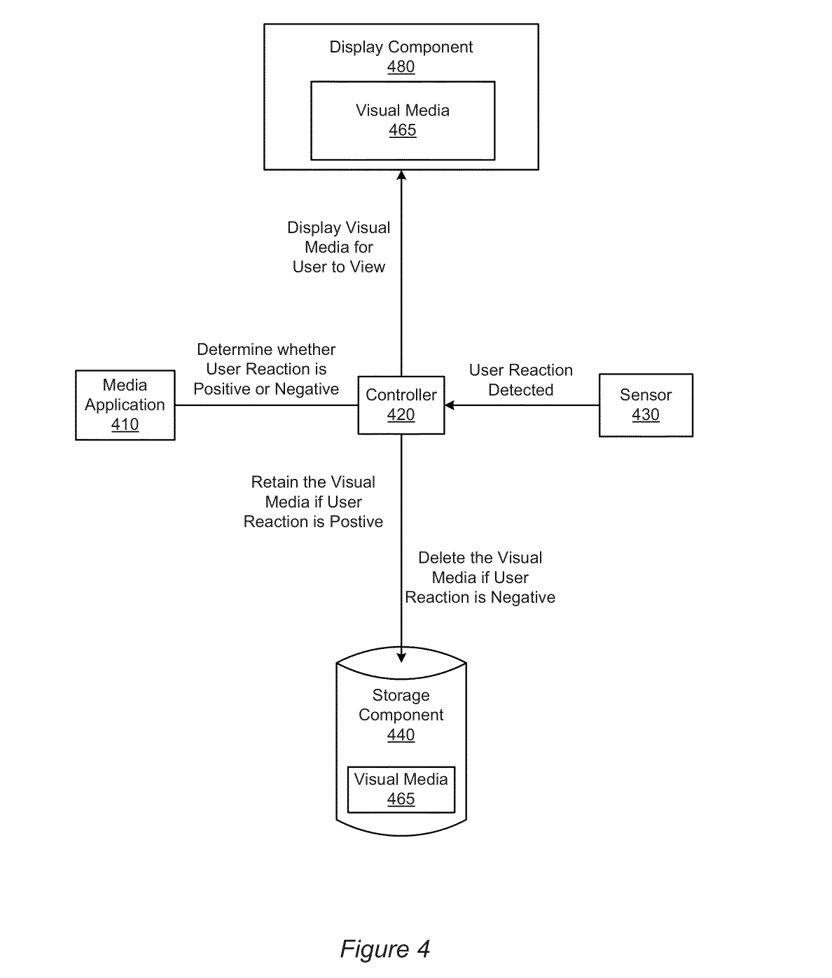

FIG. 4 illustrates a block diagram of a media application 410 determining whether to retain visual media 465 based on a user reaction according to an example. In one embodiment, the media application 410 and/or the controller 420 can display the stored visual media 465 on a display component 480 for a user to view. As the user views the visual media 465, a sensor 430 can detect for a user reaction. The sensor 430 can be an image capture component and/or an audio input component configured to detect for a visual reaction and/or an audio reaction from the user.

For the purposes of this application, the user reaction can be identified by the controller 420 and/or the media application 410 as a positive reaction or a negative reaction based on how the user perceives the displayed visual media 465. In response to the sensor 430 detecting a visual reaction and/or an audio reaction from the user, the media application 410 and/or the controller 420 can determine whether the user reaction is positive or negative. The media application 410 and/or the controller 420 can user facial detection technology and/or facial expression analysis technology to determine whether a visual reaction from the user is positive or negative. Additionally, the media application 410 and/or the controller 420 can use voice recognition technology, audio processing technology, and/or audio analysis technology to determine whether the audio reaction from the user is positive or negative.

If the media application 410 and/or the controller 420 determine that the visual or audio reaction from the user is positive, the media application 410 and/or the controller 420 can retain the visual media 465 on the storage component 440. In another embodiment, the media application 410 and/or the controller 420 can additionally prompt the user to specify one or more portion of the visual media 465 to retain on the storage component 440. The media application 410 and/or the controller 420 can then proceed to retain, on the storage component 440, portions of the visual media 465 identified to be retained and delete any remaining portions of the visual media 465.

If the media application 410 and/or the controller 420 determine that the visual or audio reaction from the user is negative, the media application 410 and/or the controller 420 can delete the visual media 465 from the storage component 440. In another embodiment, the media application 410 and/or the controller 420 can prompt the user to specify which portions of the visual media 465 to delete from the storage component 440. The media application 410 and/or the controller 420 can then proceed to delete the identified portions of the visual media 465 to be deleted and leave on the storage component 440 any remaining portions of the visual media 465.

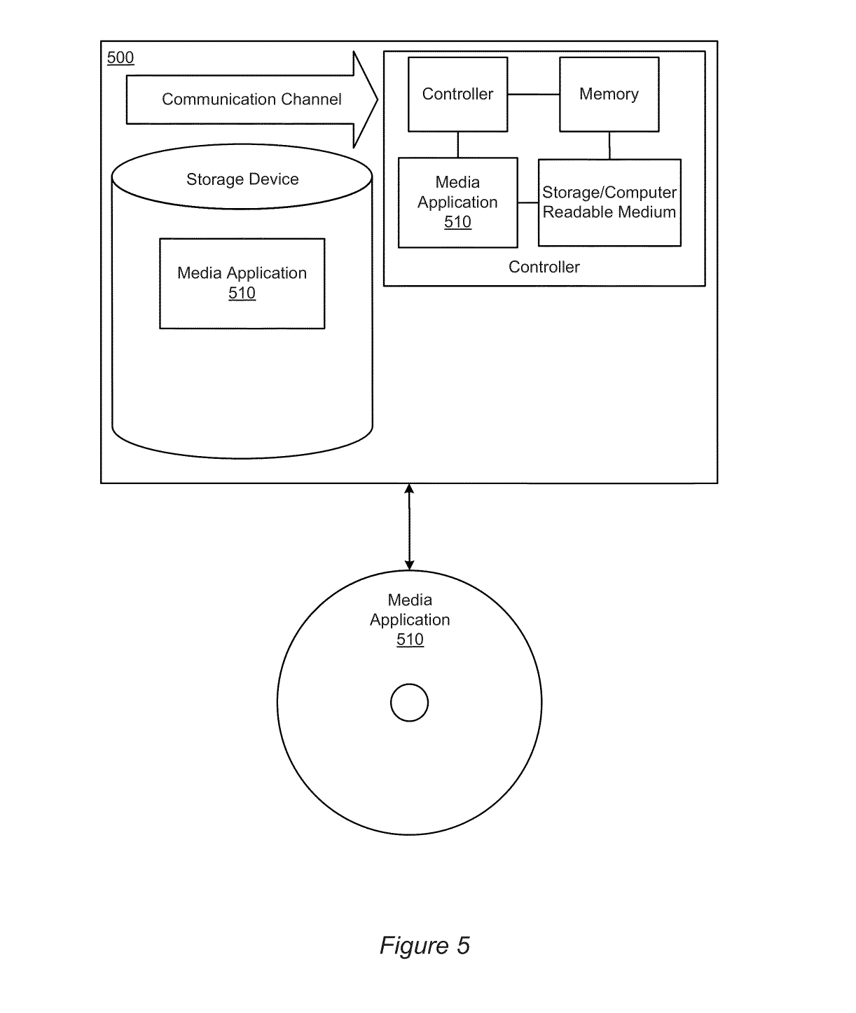

FIG. 5 illustrates a media application 510 on a device 500 and the media application 510 stored on a removable medium being accessed by the device 500 according to an embodiment. For the purposes of this description, a removable medium is any tangible apparatus that contain, stores, communicates, or transports the application for use by or in connection with the device 500. As noted above, in one embodiment, the media application 510 is firmware that is embedded into one or more components of the device 500 as ROM. In other embodiments, the media application 510 is an application which is stored and accessed from a hard drive, a compact disc, a flash disk, a network drive or any other form of computer readable medium that is coupled to the device 500.

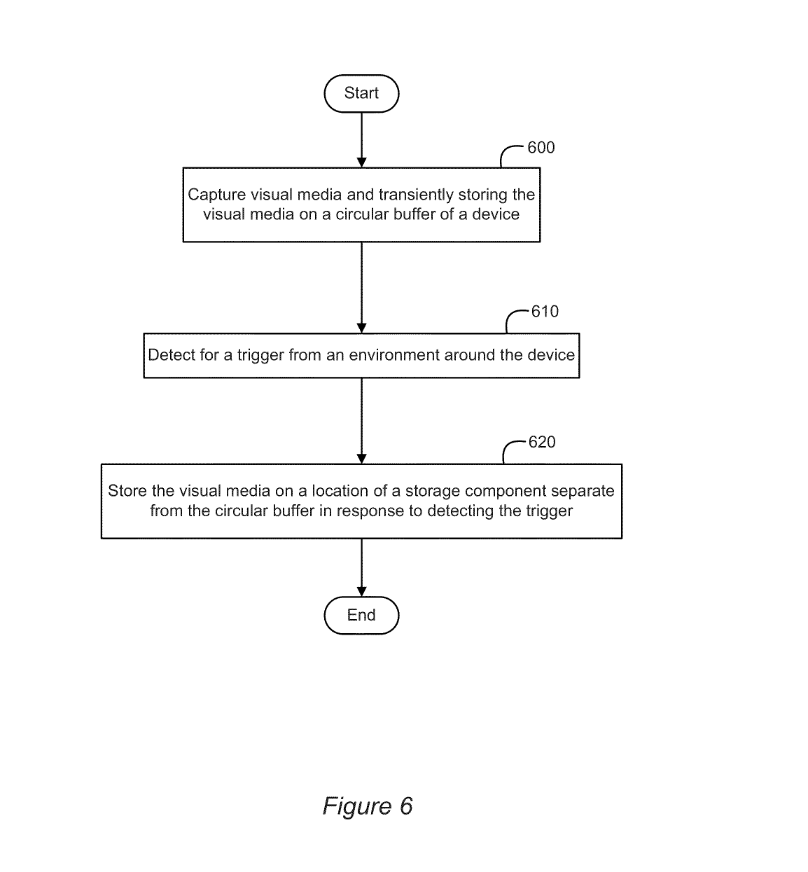

FIG. 6 is a flow chart illustrating a method for managing visual media according to an embodiment. A media application can be utilized independently and/or in conjunction with a controller of the device to manage visual media. As noted above, the visual media can be an image, video, or audio/video of a person, object, event, and/or scene captured within a view of an image capture component. The image capture component can capture the visual media and the visual media can be transiently stored on a circular buffer of the device at 600. In one embodiment, the image capture component can capture the visual media in response the device powering on and/or in response to the device entering an image capture mode.

The circular buffer can be a portion or location of a storage device configured to transiently store the visual media. In another embodiment, the circular buffer can be a separate storage device. As visual media is continuously captured, the new or recently captured visual media can be stored on the circular buffer while existing visual media already included on the circular buffer can be deleted. In one embodiment, a FIFO (first in first out) policy is implemented by the controller and/or the media application when managing the visual media on the circular buffer.

As the visual media is transiently stored on the circular buffer, a sensor of the device can detect for a trigger from an environment around the device at 610. The sensor can be an image capture component and/or an audio input component, such as a microphone. When detecting for a trigger, the sensor can detect the environment around the device for a visual event and/or an audio event. The environment can include a location or space of where the device is located. In response to detecting a trigger, the controller and/or the media application can store the visual media onto a location of a storage component separate from the circular buffer at 620. If the circular buffer is included on the storage component, the controller and/or the media application can copy or move the visual media from the circular buffer to another location of the storage component separate from the circular buffer.

If the circular buffer is included on another storage component, the controller and/or the media application can copy or move the visual media from the other storage device with the circular buffer to the storage component. In one embodiment, the controller and/or the media application additionally delete the visual media from the circular buffer. The method is then complete. In other embodiments, the method of FIG. 6 includes additional steps in addition to and/or in lieu of those depicted in FIG. 6.

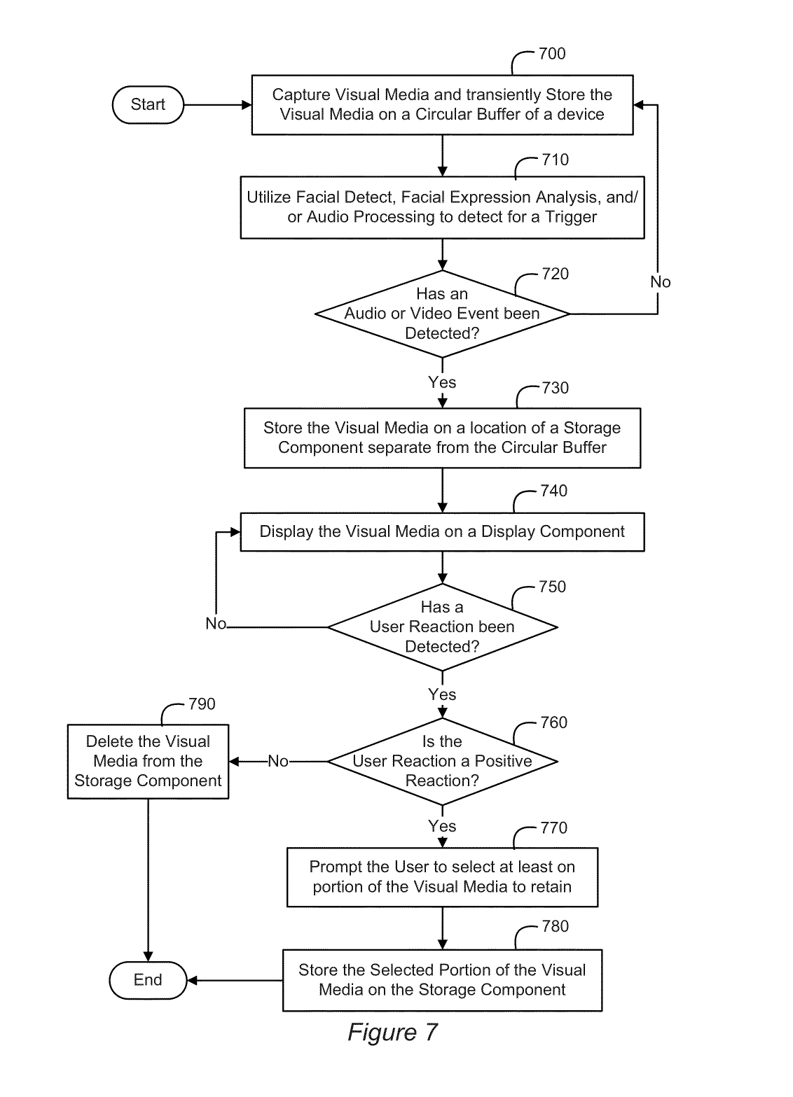

FIG. 7 is a flow chart illustrating a method for managing visual media according to another embodiment. An image capture component can initially capture visual media and transiently store the visual media on a circular buffer of the device at 700. As the visual media is transiently stored on the circular buffer, a sensor can be utilized in conjunction with facial detection technology, facial expression analysis technology, audio processing technology and/or voice recognition technology for the media application and/or the controller to detect for a trigger from an environment around the device at 710.

The media application and/or the controller can determine whether a visual event and/or an audio event have been detected at 720. If the media application and/or the controller determine that a laugh, a yell, a clap, an increase in volume, and/or music playing is detected, an audio event will be detected. If the media application determines that a change in expression from a user or person, a smile from the user or person, and/or a surprised facial reaction from the user or person are detected, a visual event will be detected.

If no visual event and no audio event are detected, the visual media is continued to be captured and transiently stored at 700 and the media application and/or the controller continue to detect for a trigger at 720. If an audio event and/or a video event are detected, the media application and/or the controller determine that a trigger has been detected and proceed to store the visual media on a location of a storage component separate from the circular buffer at 730.

The media application and/or the controller can then display the visual media on a display component of the device at 740. One or more sensors can then be utilized for the media application and/or the controller to detect for a visual reaction and/or an audio reaction from a user viewing the visual media at 750. If no user reaction is detected, the visual media can continue to be displayed for the user to view at 740. If a user reaction has been detected, the media application and/or the controller can use facial detection technology, facial expression analysis technology, and/or audio processing technology to determine whether the user reaction is positive or negative at 760.

If the user reaction is determined to be negative, the media application and/or the controller can proceed to delete the visual media from the storage component at 790. In one embodiment, the user can additionally be prompted through the display component to specify which portions of the visual media to delete. The media application and/or the controller can then proceed to delete the specified portions of the visual media while retaining any other portion of the visual media. In another embodiment, if the user reaction is positive, the media application and/or the controller can proceed to retain the visual media on the storage component. The user can additionally be prompted to specify which portion of the visual media to retain at 770. The media application and/or the controller can then retain the specified portion of the visual media on the storage component while deleting any remaining portions of the visual media at 780. The method is then complete. In other embodiments, the method of FIG. 7 includes additional steps in addition to and/or in lieu of those depicted in FIG. 7.

What is claimed is:

1. A method for managing visual media comprising:
capturing visual media and transiently storing the visual media on a circular buffer of a device;
detecting for a trigger from an environment around the device; and
storing the visual media on a location of a storage component separate from the circular buffer in response to detecting the trigger.

2. The method for managing visual media of claim 1 wherein detecting for the trigger includes the sensor detecting for at least one of a visual event and an audio event.

3. The method for managing visual media of claim 2 wherein detecting for a visual event includes the sensor detecting for at least one of a change in a facial expression of a user, a smile from the user, a surprised facial expression from the user.

4. The method for managing visual media of claim 2 wherein detecting for an audio event includes the sensor detecting for at least one of a laugh, a yell, a clap, a volume increase, and music playing.

5. The method for managing visual media of claim 1 further comprising displaying the stored visual media on a display component for the user to view and detecting a user reaction from the user viewing the visual media.

6. The method for managing visual media of claim 5 further comprising prompting the user to select at least one portion of the visual media to retain in the storage component if the user reaction is a positive reaction.

7. The method for managing visual media of claim 5 further comprising deleting the visual media from the storage component if the user reaction is a negative reaction.

8. A device comprising:
an image capture component to capture visual media;
a circular buffer to transiently store the visual media;
a sensor to detect a trigger from an environment around the device; and
a controller to store the visual media on a location of a storage component separate from the circular buffer in response to detecting the trigger.

9. The device of claim 8 further comprising an audio input component to capture audio as part of the visual media.

10. The device of claim 8 further comprising a display component for the user to view the visual media.

11. The device of claim 8 wherein the sensor includes an audio input component to detect an audio event from the environment or a user of the device.

12. The device of claim 10 wherein the sensor includes a second image capture component to capture a visual event from a user of the device.

13. The device of claim 12 wherein the image capture component is coupled to a front panel of the device and the display component and the second image capture component are coupled to a rear panel of the device opposite of the front panel.

14. A computer readable medium comprising instructions that if executed cause a controller to:
capture visual media and transiently store the visual media on a circular buffer of a device;
detect for a trigger from an environment around the device; and
store at least one portion of the visual media on a location of a storage component separate from the circular buffer in response to detecting the trigger.

15. The computer readable medium comprising instructions of claim 14 wherein the controller utilizes at least one of facial detection, facial expression analysis, and audio processing when detecting for the trigger from the environment.
